(19) United States
(12) Patent Application Publication
(10) Pub. No.: US 2022/0178177 A1
(43) Pub. Date: Jun. 9, 2022

(54) Clothing Tag

(71) Applicants: Linda FAIRWEATHER, Mornington (AU); George KOTSIOPOULOS, Mornington (AU)

(72) Inventors: Linda FAIRWEATHER, Mornington (AU); George KOTSIOPOULOS, Mornington (AU)

(21) Appl. No.: 17/604,723

(22) PCT Filed: Apr. 16, 2020
(86) PCT No.: PCT/AU2020/050375

§ 371 Date: Oct. 18, 2021

(30) Foreign Application Priority Data
Apr. 17, 2019 (AU) 2019901332

(51) Int. Cl. E05B 73/00

(52) U.S. Cl. CPC E05B 73/0017

(57) ABSTRACT

A clothing tag (10) comprising first side and second side members (12, 14) pivotable to a closed position to capture a portion of material (11). A first connector (43) is provided on a frangible base comprising a disc (51) secured relative to the first side member (12) by a plurality of connecting portions (52) around the periphery thereof. A second connector (45) is provided on the second side member (14) such that the first connector (43) engages with the second connector (45) when the first and second side members 12 and 14 are closed. Rotation of an actuator severs the connecting portions (52) such that the first connector (43) is broken away from the first side member (12), thereby allowing the first and second side members (12, 14) to be moveable to an open position to release the material 11.

### FIELD OF THE INVENTION

The present invention relates to a tag to be secured to clothing.

### BACKGROUND TO THE INVENTION

The returning of purchased clothing has become a significant issue for the clothing industry. As clothing purchased online usually has a fairly generous return period, it is common for consumers to purchase an item, wear the item to an event, and then return the item for a full refund. This type of behaviour also has a significant impact on retailers selling clothing through conventional retail outlets as well as clothing designers. It impacts both the retailers and designers financially, as well as consumers who may be purchasing an item of clothing which has been purchased and worn previously.

Devices have been proposed previously for attachment to new clothing which must be removed before wear. The removal of the device can therefore be used as an indication that the clothing has been worn and cannot therefore be returned. The present invention relates to an improved arrangement of such a tag that is both simple and effective to use.

### SUMMARY OF THE INVENTION

According to one aspect of the present invention there is provided a clothing tag comprising:
a first side member and a second side member, the first and second side members being pivotally connected to each other at first ends thereof such that the first and second side members are pivotable between a closed position, in which a portion of material may be captured between the first and second side members, and an open position, in which the portion of material is released;
a first connector provided on a frangible base comprising a disc secured relative to the first side member by a plurality of connecting portions around the periphery thereof;
a second connector provided on the second side member such that the first connector engages with the second connector in the closed position to secure the first and second side members in the closed position;
an actuator on the first side member being operable by hand;
wherein rotation of the actuator severs the connecting portions such that the first connector is broken away from the first side member, thereby allowing the first and second side members to be moveable to the open position.

Preferably the actuator comprises a base portion having a plurality of lugs received in spaces between the connecting portions to secure the actuator relative to the first side member and a handle which may be gripped to rotate the base portion such that sharpened edges of the lugs sever the connecting portions.

Preferably the base portion of the actuator comprises a circular base portion and the lugs are flexible and include widened distal ends to engage through the spaces between the connecting portions in a snap fit manner such that the actuator is held in place against the frangible base.

Preferably edges of the flexible lugs are sharpened such that rotation of the actuator by the handle causes the sharpened edges to engage with the connecting portions and sever the connecting portions.

In a preferred embodiment, the first connector comprises one or more first arms, the second connector comprises one or more second arms and each of the first arms includes triangular teeth on a first side thereof to engage with triangular teeth on a first side of a corresponding one of the second arms.

Preferably the clothing tag includes a pin adjacent the first end of the first side member to pierce through the portion material when the material is captured between the first and second side members.

Preferably the pin comprises a head and a shaft having a sharpened distal end, the head being received in a recess defined by a cylindrical protrusion on the first side member adjacent the second end thereof.

Preferably the periphery of the head is provided with a plurality of flexible tabs to engage with the inner surface of the cylindrical protrusion and secure the pin within the recess defined by the cylindrical protrusion.

Preferably the second side member is provided with a pinhole in the first side surface, adjacent the first end thereof to receive the shaft of the pin.

Preferably the second side member is provided with a pin storage hole to receive shaft of the pin such that when the pin is received through the pin storage, the first and second side members are prevented from moving to the closed position.

Preferably the first side members is provided with an outwardly extending first wall and the second side member is provided with an outwardly extending second wall, the first and second side walls extending transversely across the first and second side members respectively such that the first and second side walls are located adjacent each other in the closed position to restrict movement of the material beyond the walls towards the first ends of the first and second side members.

In one embodiment, the first side member is provided with a first insert located adjacent the first surface thereof and the second side member is provided with a second insert located adjacent the first surface thereof.

Preferably the first insert includes the frangible base and first connector.

Preferably the second insert includes the pinhole.

Preferably the first insert includes the first wall and the second insert includes the second wall.

### BRIEF DESCRIPTION OF THE DRAWINGS

The invention will now be described, by way of example, with reference to the following drawings, in which:

FIG. 1 is an upper perspective view of a clothing tag in accordance with the present invention;

FIG. 2 is an upper perspective view of the clothing tag of FIG. 1 in a fully open position;

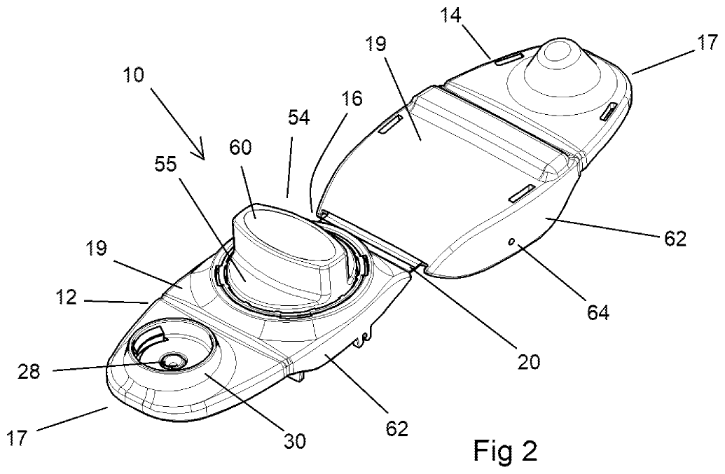

FIG. 3 is a lower perspective view of the clothing tag of FIG. 1 in the fully open position;

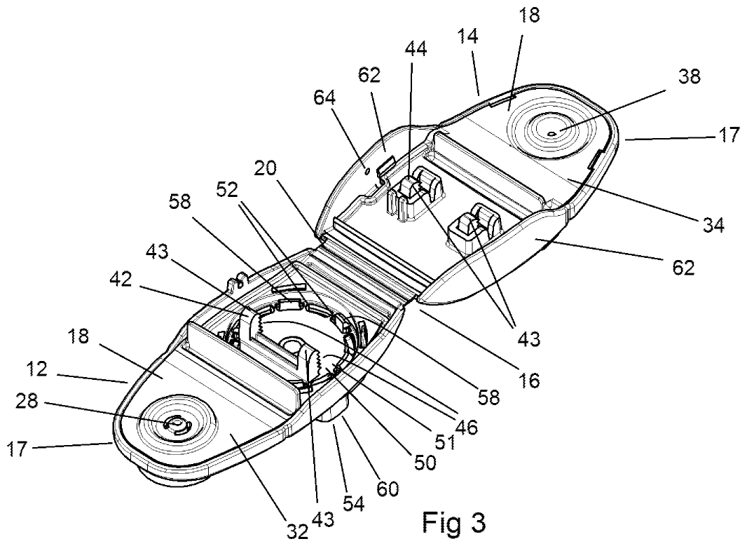

FIG. 4 is a first exploded view of the clothing tag of FIG. 1;

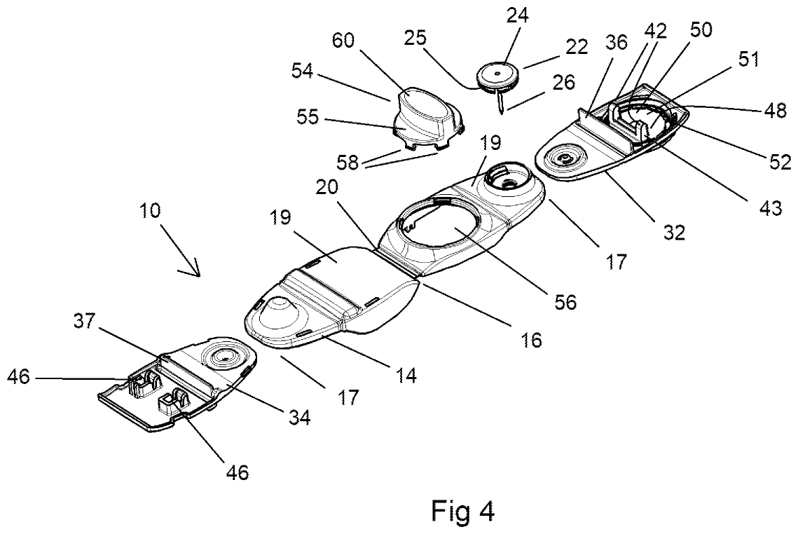

FIG. 5 is a second exploded view of the clothing tag of FIG. 1;

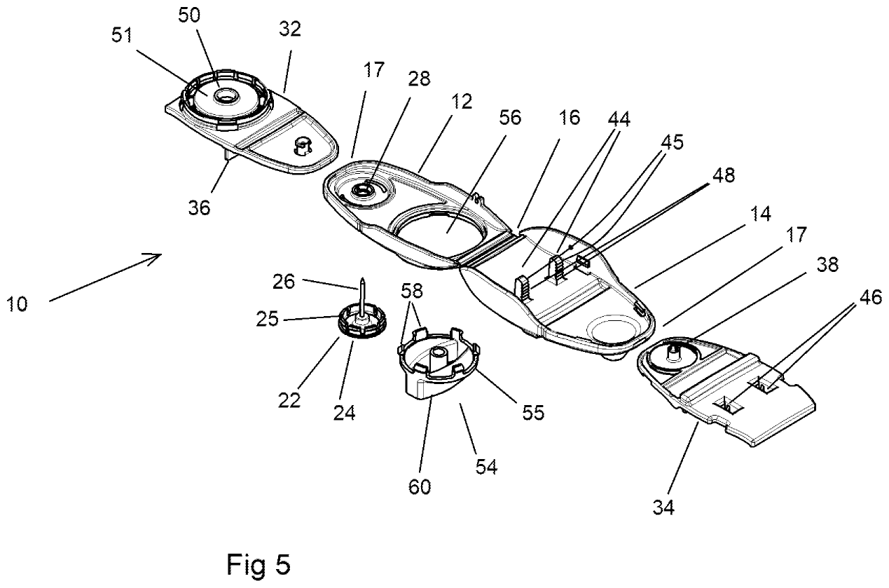

FIG. 6 is a third exploded view of the clothing tag of FIG. 1;

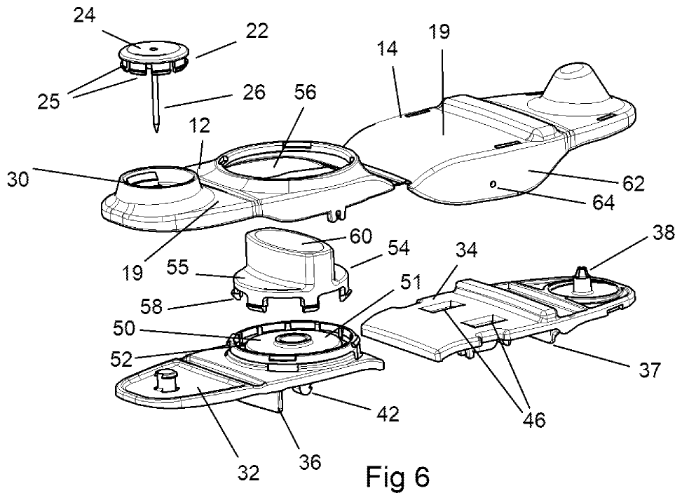

FIG. 7 is the third exploded view of the clothing tag of FIG. 1 showing the actuator attached;

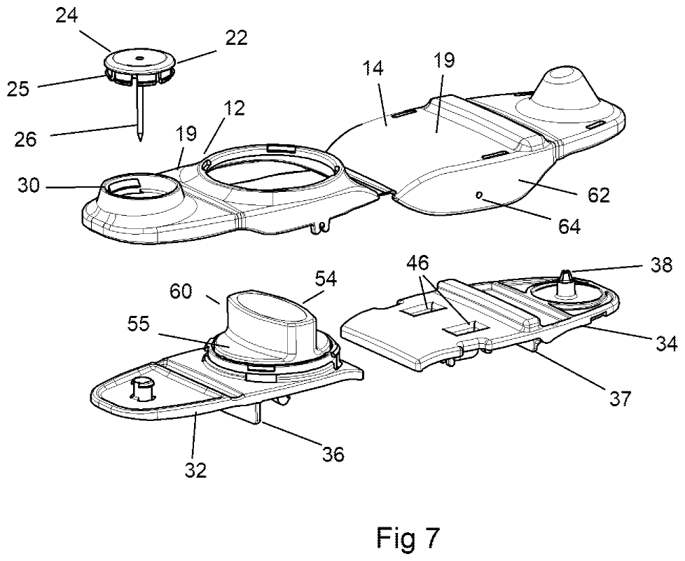

FIG. 8 is a side view of the clothing tag of FIG. 1 in the closed position;

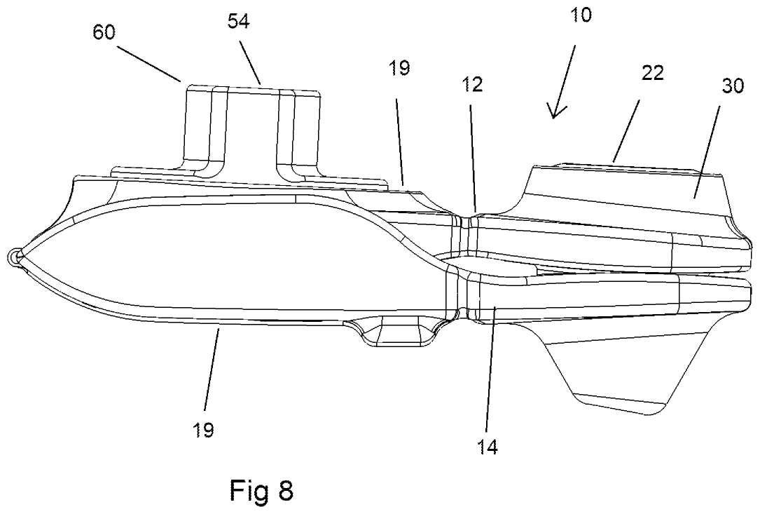

FIG. 9 is a side cross-sectional view of the clothing tag of FIG. 1 moving towards the closed position;

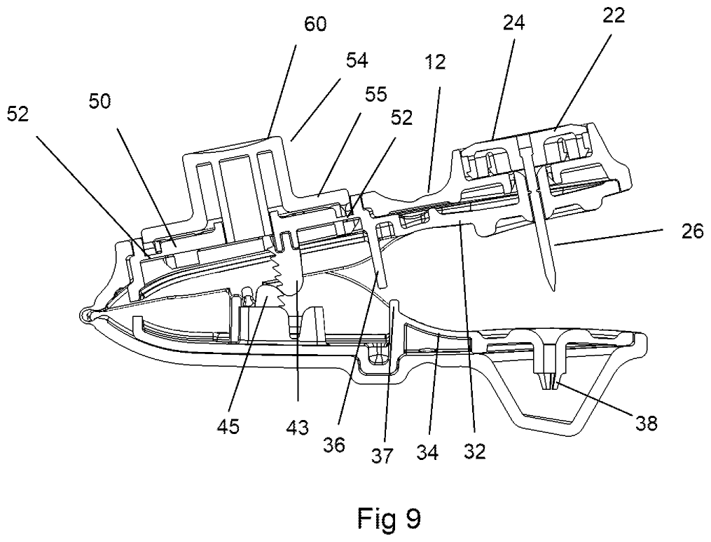

FIG. 10 is a side cross-sectional view of the clothing tag of FIG. 1 showing initial engagement between the connectors;

FIG. 11 is a side cross-sectional view of the clothing tag of FIG. 1 showing further engagement of the connectors;

FIG. 12 is a side cross-sectional view of the clothing tag of FIG. 1 in the closed position engaged with a portion of material;

FIG. 13 is a close-up cross-sectional view showing engagement of the connectors;

FIG. 14 is an upper perspective view of the clothing tag of FIG. 1 in the open position showing the positioning of a portion of material of a garment and with the frangible base broken away; and

FIG. 15 is an upper perspective view of the clothing tag of FIG. 1 in the open position with the frangible base broken away from the first side member; and

FIG. 16 is a side cross-sectional view of the clothing tag of FIG. 1 in the open position with the frangible base broken away from the first side member.

### DETAILED DESCRIPTION OF PREFERRED EMBODIMENTS

Referring to the Figures, there is shown a clothing tag 10 comprising a first side member 12 and a second side member 14. Each of the first and second side members 12 and 14 includes a first end 16 and a second and 17. The first end 16 of the first side member 12 is pivotally connected to the first end 16 of the second side member 14 such that the first and second side members 12 and 14 are movable between a closed position and an open position.

In the embodiment shown, each of the first and second side members 12 and 14 comprises generally planar member having a first side surface 18 and a second side surface 19. In the closed position, the first side surface 18 of the first side member 12 is located adjacent the first side surface 18 of the second side member 14 such that a portion of material 11 may be captured between the first and second side members 12 and 14. The first side surfaces 18 of the first and second side members 12 and 14 move away from each other as the clothing tag 10 moves to the open position to release the portion of material 11 from the clothing tag 10.

The first end 16 of the first side member 12 in the embodiment shown is connected to the first end 16 of the second side member 14 by a flexible web 20. The web 20 is sufficiently flexible to allow the first and second side members 12 and 14 to move between the open and closed positions. The first and the second side members 12 and 14 and the web 20 in embodiment shown are integrally formed of a suitable material, such as a plastic material. The clothing tag 10 includes a pin 22 provided to pierce through the portion material 11 when the material 11 is captured between the first and second side members 12 and 14. The pin 22 comprises a head 24 and a shaft 26 having a sharpened distal end.

A hole 28 is provided passing through the first side member 12 adjacent the second end 17 thereof for receiving the shaft 26 of the pin 22 such that the head 24 of the pin 22 is located adjacent the second side surface 19 of the first side member 12. The head 24 the pin 22 is circular in the embodiment shown and the second side surface 19 is provided with a cylindrical protrusion 30 around the hole 28 such that the head 24 is received into the recess defined by the cylindrical protrusion 30 as the shaft 26 passes through the hole 28. The periphery of the head 24 is provided with a plurality of flexible tabs 25 to engage with the inner surface of the cylindrical protrusion 30 and secure the pin 22 within the recess defined by the cylindrical protrusion 30.

The first side member 12 in embodiment shown is provided with a corresponding first insert 32 and the second side member 14 is provided with a corresponding second insert 34. Each of the first and second inserts 32 and 34 comprises a planar member locatable adjacent the first side surface 18 of the respective side member 12 or 14.

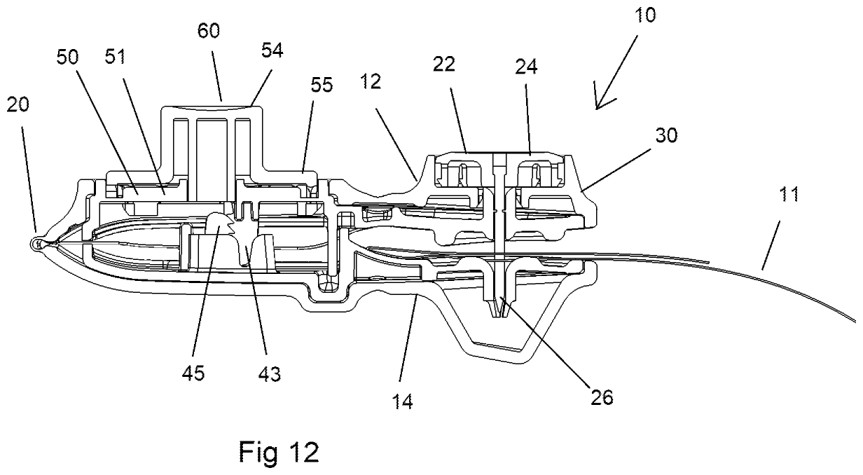

The first insert 32 is provided with an outwardly extending first wall 36 and the second insert 34 is provided with an outwardly extending second wall 37. The first wall 36 extends transversely across the first insert 32 between the first and second ends 16 and 17 of the first side member 12. The second wall 37 extends transversely across the second insert 34 between the first and second ends 16 and 17 of the second side member 14. When the first and second side members 12 and 14 move to the closed position, the first and second walls 36 and 37 are located adjacent each other (as can be seen in FIG. 12) to restrict movement of the material 11 beyond the walls 36 and 37 towards the first ends 16 of the first and second side members 12 and 14.

The second side member 14 is provided with a pinhole 38 in the first side surface 18, adjacent the first end 16 thereof. The pinhole 38 in the embodiment shown is provided in the second insert 34. The pinhole 38 is provided to receive the distal end of the shaft 26 of the pin 22 when the clothing tag 10 moves to the closed position. As can be seen in FIG. 12, the shaft 26 of the pin 22 punctures the material 11 when the clothing tag 10 is in the closed position such that the material 11 cannot be removed from the clothing tag 10.

The first side member 12 is provided with one or more first connectors 42 and the second side member 14 is provided with one or more second connectors 44. The first connectors 42 are provided to engage with the second connectors 44 when the first and second side members 12 and 14 move to the closed position, to prevent the first and second side members 12 and 14 moving back to the open position. In the embodiment shown, the first connectors 42 comprise a pair of first arms 43 extending outwardly from the first insert 32. The second connectors 44 comprise a pair of second arms 45 extending outwardly from the first side surface 18 of the second side member 14. The second arms 45 pass through corresponding openings 46 in the second insert 34. The first and second arms 43 and 45 are located between the first and second walls 36 and 37 and the first ends 16 of the first and second side members 12 and 14.

Each of the first and second arms 43 and 45 includes teeth 48 on a side thereof such that the teeth 48 on the first arms 43 engage with the teeth 48 on the second arms 45 when the clothing tag 10 moves to the closed position. The teeth 48 are triangular in shape such that as the first and second side members 12 and 14 move towards the closed position, the teeth 48 engage to restrict movement of the first and second side members 12 and 14 back towards the open position.

The first connectors 42 are provided on a frangible base 50 provided on the first insert 32. The frangible base 50 comprises a disk 51 connected to the body of the first insert 32 by a plurality of connecting portions 52. The connecting portions 52 comprise portions of material extending radially outwardly from the periphery of the disk 51 to the body of the insert 32 such that the connecting portions 52 may be broken to disconnect the base 50 from the first insert 32.

The first side member 12 is provided also with an actuator 54 which is operable to sever the connecting portions 52 and thereby release the base 50 and the first connectors 42 from the first side member 12. The actuator 54 comprises a circular base portion 55 which is received through a corresponding opening 56 in the first side member 12. The circular base portion 55 includes a plurality of flexible lugs 58 which pass around the frangible base 50 through the spaces defined between the connecting portions 52. The flexible lugs 58 include widened distal ends to engage through the spaces between the connecting portions 52 in a snap fit manner such that the actuator 54 is held in place against the frangible base 50.

The actuator 54 includes a handle 60 extending outwardly from the base portion 55 thereof such that the handle 60 can be gripped to rotate the actuator 54. Edges of the flexible lugs 58 are sharpened such that rotation of the actuator 54 by the handle 60 causes the sharpened edges to engage with the connecting portions 52 and sever the connecting portions 52. Rotation of the actuator 54 releases the frangible base 50 and the first connectors 44 from the first side member 12.

The first and second side members 12 and 14 include also transverse flange portions 62 along longitudinal edges thereof adjacent the first ends 16. One of the flange portions 62 on the second side member 14 is provided with a pin storage hole 64 to receive shaft 26 of the pin 22. When the pin 20 is received through the pin storage hole 64, the first and second side members 12 and 14 are prevented from moving to the closed position.

It will be appreciated that while the structure of the clothing tag 10 is described has having the first and second inserts 32 and 34, each having a number of features, the use of the first and second inserts 32 and 34 is described as it is expected this would make manufacturing of the clothing tag 10 easier. It would be possible however to include the features of the first and second inserts 32 and 34 onto the first and second side members 12 and 14 so that the clothing tag 10 comprises a single piece only.

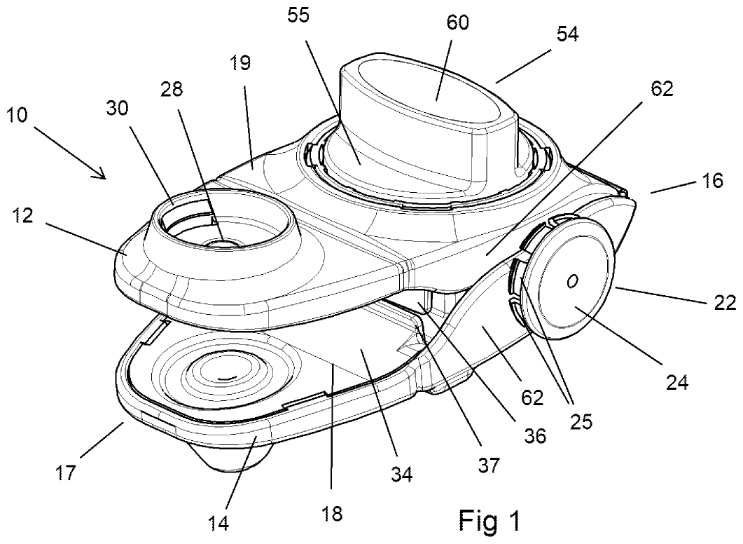

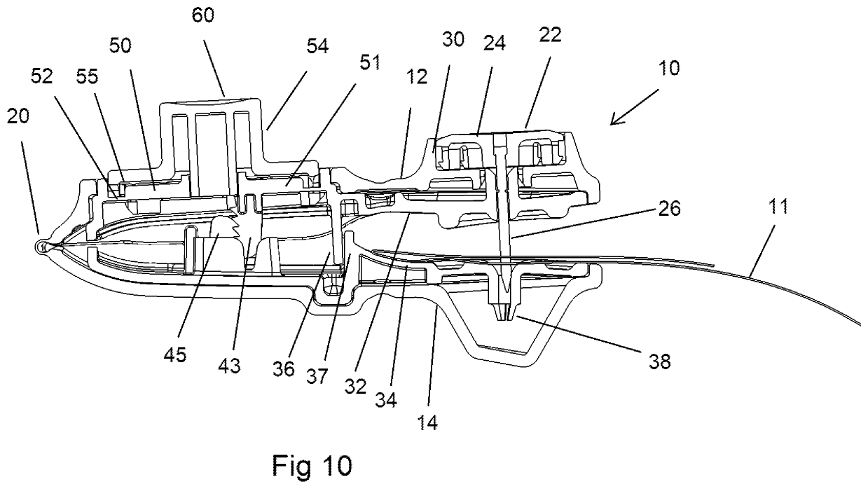

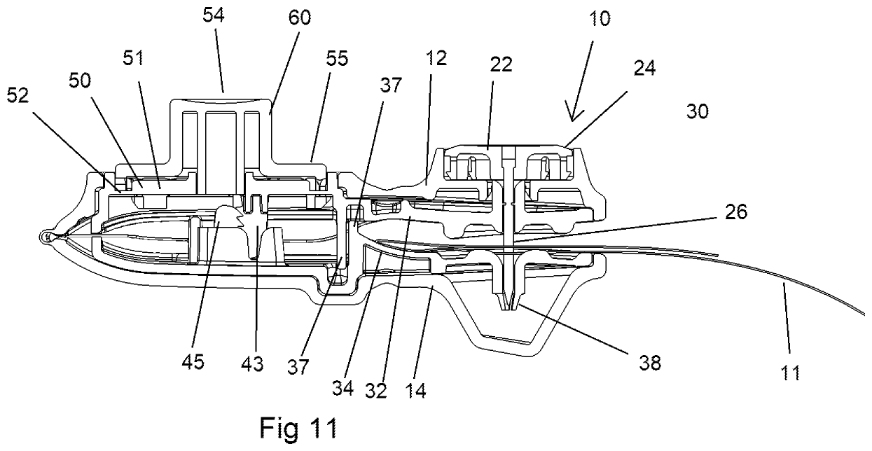

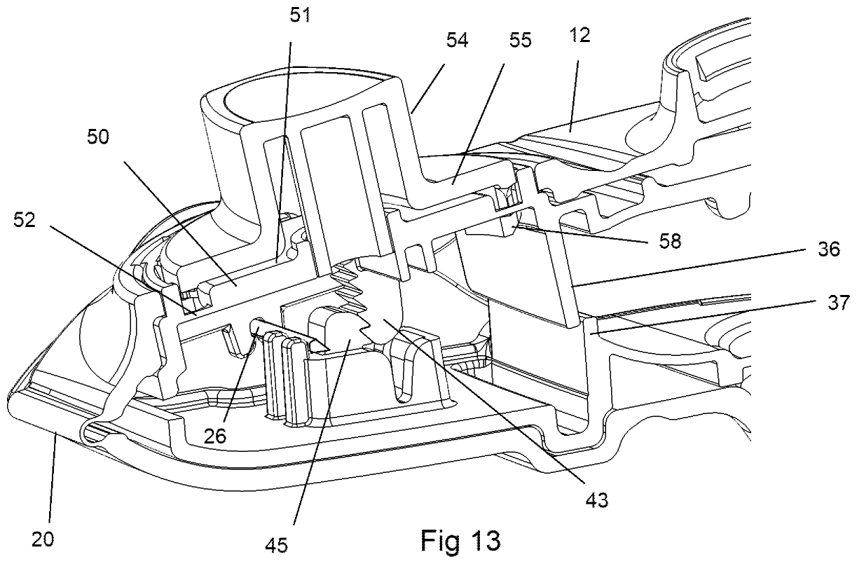

In use, the clothing tag 10 is provided with the pin 22 supported in the pin storage hole 64 as can be seen in FIG. 1. This prevents the clothing tag 10 from moving to the closed position until required for use. The pin 22 may be removed and inserted through the hole 28 in the first side member 12 and a portion of material 11 placed between second ends 17 of the first and second side members 12 and 14. As can be seen in FIGS. 10 to 14, the first and second side members 12 and 14 may be moved together such that the first and second connectors 42 and 44 engage, thereby trapping the material 11 between the first and second side members 12 and 14.

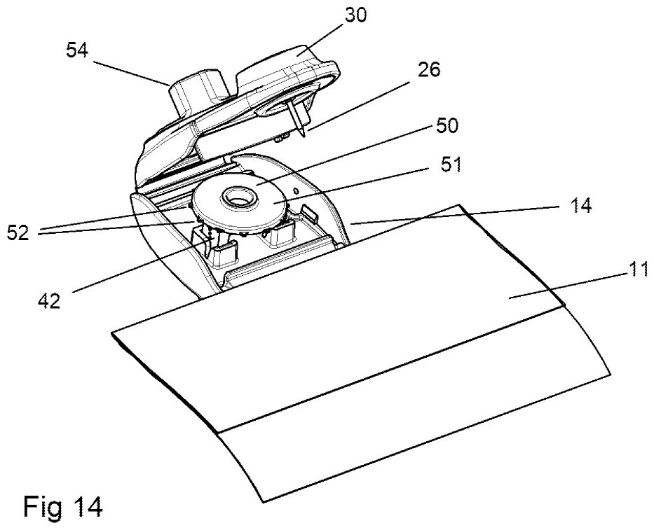

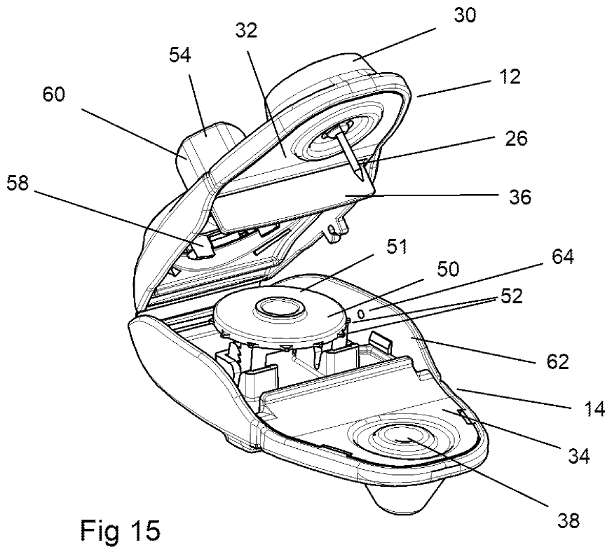

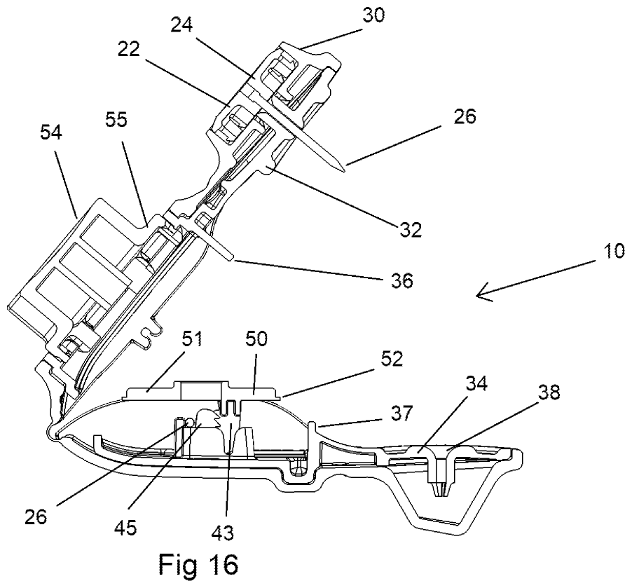

The clothing tag 10 is expected to be connected in this way to a new item of clothing in a location which would be obvious should someone wear the garment. Should someone wish to wear the garment, they will therefore need to remove the clothing tag 10. To remove the clothing tag 10, the actuator 54 is gripped and rotated, thereby severing the frangible base 50, as can be seen in FIGS. 14 to 16. The first side member 12 is then free to move back to the open position such that the pin 22 is released from the material 11 and the clothing tag 10 is free to be removed from the garment. As the frangible base 50 is now broken away from the clothing tag 10, the clothing tag 10 cannot be reattached to the garment. The removal of the clothing tag 10 provides an indication that the garment has been worn and the seller of the garment may therefore elect not to allow return of the garment.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A clothing tag comprising:
a first side member and a second side member, the first and second side members being pivotally connected to each other at first ends thereof such that the first and second side members are pivotable between a closed position, in which a portion of material may be captured between the first and second side members, and an open position, in which the portion of material is released;
a first connector provided on a frangible base comprising a disc secured relative to the first side member by a plurality of connecting portions around the periphery thereof;
a second connector provided on the second side member such that the first connector engages with the second connector in the closed position to secure the first and second side members in the closed position;
an actuator on the first side member being operable by hand;
wherein rotation of the actuator severs the connecting portions such that the first connector is broken away from the first side member, thereby allowing the first and second side members to be moveable to the open position.

17. A clothing tag in accordance with claim 16, wherein the actuator comprises a base portion having a plurality of lugs received in spaces between the connecting portions to secure the actuator relative to the first side member and a handle which may be gripped to rotate the base portion such that sharpened edges of the lugs sever the connecting portions.

18. A clothing tag in accordance with claim 17, wherein the base portion of the actuator comprises a circular base portion and the lugs are flexible and include widened distal ends to engage through the spaces between the connecting portions in a snap fit manner such that the actuator is held in place against the frangible base.

19. A clothing tag in accordance with claim 18, wherein edges of the flexible lugs are sharpened such that rotation of the actuator by the handle causes the sharpened edges to engage with the connecting portions and sever the connecting portions.

20. A clothing tag in accordance with claim 16, wherein the first connector comprises one or more first arms, the second connector comprises one or more second arms and each of the first arms includes triangular teeth on a first side thereof to engage with triangular teeth on a first side of a corresponding one of the second arms.

21. A clothing tag in accordance with claim 16, wherein the clothing tag includes a pin adjacent the first end of the first side member to pierce through the portion material when the material is captured between the first and second side members.

22. A clothing tag in accordance with claim 21, wherein the pin comprises a head and a shaft having a sharpened distal end, the head being received in a recess defined by a cylindrical protrusion on the first side member adjacent the second end thereof.

23. A clothing tag in accordance with claim 22, wherein the periphery of the head is provided with a plurality of flexible tabs to engage with the inner surface of the cylindrical protrusion and secure the pin within the recess defined by the cylindrical protrusion.

24. A clothing tag in accordance with claim 23, wherein the second side member is provided with a pinhole in the first side surface, adjacent the first end thereof to receive the shaft of the pin.

25. A clothing tag in accordance with claim 24, wherein the second side member is provided with a pin storage hole to receive shaft of the pin such that when the pin is received through the pin storage, the first and second side members are prevented from moving to the closed position.

26. A clothing tag in accordance with claim 16, wherein the first side member is provided with an outwardly extending first wall and the second side member is provided with an outwardly extending second wall, the first and second side walls extending transversely across the first and second side members respectively such that the first and second side walls are located adjacent each other in the closed position to restrict movement of the material beyond the walls towards the first ends of the first and second side members.

27. A clothing tag in accordance with claim 16, wherein the first side member is provided with a first insert located adjacent the first surface thereof and the second side member is provided with a second insert located adjacent the first surface thereof.

28. A clothing tag in accordance with claim 27, wherein the first insert includes the frangible base and first connector.

29. A clothing tag in accordance with claim 27, wherein the second insert includes the pinhole.

30. A clothing tag in accordance with claim 26, wherein the first insert includes the first wall and the second insert includes the second wall.

31. A clothing tag in accordance with claim 27, wherein the first insert includes the first wall and the second insert includes the second wall.

32. A clothing tag in accordance with claim 28, wherein the first insert includes the first wall and the second insert includes the second wall.

33. A clothing tag in accordance with claim 29, wherein the first insert includes the first wall and the second insert includes the second wall.
